(19) United States
(12) Patent Application Publication
(10) Pub. No.: US 2007/0142513 A1
(43) Pub. Date: Jun. 21, 2007

(54) Surfactant, method of producing a fluoropolymer, fluoropolymer aqueous dispersion

(75) Inventors: Nobuhiko Tsuda, Settsu-shi (JP); Yoshinori Nanba, Settsu-shi (JP); Yasuhiko Sawada, Settsu-shi (JP); Tetsuo Shimizu, Settsu-shi (JP)

Correspondence Address: SUGHRUE MION, PLLC, 2100 PENNSYLVANIA AVENUE, N.W., SUITE 800, WASHINGTON, DC, 20037, US

(73) Assignee: DAIKIN INDUSTRIES, LTD.

(21) Appl. No.: 11/312,570

(22) Filed: Dec. 21, 2005

(51) Int. Cl. C08K 5/42

(52) U.S. Cl. 524/157; 524/544

(57) ABSTRACT

The present invention provides a surfactant making it possible to obtain particles comprising a fluoropolymer at a size smaller in diameter in an aqueous dispersion obtained by polymerization in the presence of the same. The present invention is a surfactant comprising a fluorine-containing-sulfobutanedioic-acid-ester derivative represented by the general formula (i):
Y—Rf¹—(CH₂)ₘ—OCOCH(SO₃M)-CH₂COO—(CH₂)ₙ—Rf²—Y (i)
wherein Y represents hydrogen atom or fluorine atom; when Y is hydrogen atom, one of Rf¹ and Rf² is —(CF₂CF₂)₃— and the other is —(CF₂CF₂)₂— or —(CF₂CF₂)₃— and, when Y is fluorine atom, Rf¹ and Rf² are the same or different and each is a divalent hydrocarbon group containing 1 to 4 carbon atoms and containing at least one fluorine atom; m and n are the same or different and each represents an integer of 1 to 3; and M represents NH₄, Li, Na, K or H.

This invention relates to a surfactant, a method of producing a fluoropolymer, and a fluoropolymer aqueous dispersion.

### BACKGROUND OF THE INVENTION

In addition to ammonium perfluorooctanoate in general use, various compounds have been proposed for use as surfactants in emulsion polymerization for the production of fluoropolymers.

Thus, compounds represented by Rf—(CH₂)₁—R′f-COOY (1 is 1 to 3, Rf is a perfluoroalkyl or perfluoroalkoxy containing 3 to 8 carbon atoms, R′f is a perfluoroalkylene containing 1 to 4 carbon atoms, Y is NH₄, Li, Na, K, H or an alkyl containing 1 to 8 carbon atoms) have been proposed as surfactants useful in the polymerization of fluorinated monomers (cf. Japanese Kokai Publication H10-212261 (claim 1)).

Compounds represented by C₃F₇O(CF(CF₃)CF₂O)ₗCF(CF₃)COOM (l is an integer of 0 to 2, M is H⁺, an alkali metal ion or NH₄⁺) have been proposed as surfactants to be used in the polymerization for the production of aqueous dispersions containing polytetrafluoroethylene (Japanese Kokai Publication 2001-64304 (claim 1)).

Compounds represented by C₆F₁₃—CH₂CH₂—SO₃M (M is a monovalent cation) have been disclosed as dispersants for use in the polymerization for producing aqueous dispersions containing polytetrafluoroethylene or a melt-processable tetrafluoroethylene copolymer (U.S. Pat. No. 5,688,884 (claim 1); U.S. Pat. No. 5,789,508 (claim 1)).

As for sulfonic-acid-derivative surfactants, fluorine-containing surfactants represented by Rf³(CH₂)_{l′}OCO—CH(SO₃M)-CH₂—COO(CH₂)_{m′}Rf^{3′} (wherein l′ and m′ each independently is an integer of 1 to 3, and Rf³ and Rf^{3′} is the same or different and each is an alkyl group containing 1 to 4 carbons atoms and containing at least one fluorine atom) have been proposed, with H(CF₂CF₂)₂CH₂OCOCH(SO₃Na)CH₂COOCH₂(CF₂CF₂)₂H being given as an example (Japanese Kokai Publication 2003-119204 (claim 1, page 5)).

However, these surfactants have problems: for example, they may provide fluoropolymer particles in latexes obtained by emulsion polymerization with poor dispersion stability since such particles are large in particle diameter, or the moldings obtained using, as a molding material, such fluoropolymer particles recovered may be poor in physical characteristics.

### SUMMARY OF THE INVENTION

In view of the above-discussed state of the art, it is an object of the present invention to provide a surfactant making it possible to obtain particles comprising a fluoropolymer at a size smaller in diameter in an aqueous dispersion obtained by polymerization in the presence of the same.

The present invention is a surfactant comprising a fluorine-containing-sulfobutanedioic-acid-ester derivative represented by the general formula (i):
Y—Rf¹—(CH₂)ₘ—OCOCH(SO₃M)-CH₂COO—(CH₂)ₙ—Rf²—Y (i)
wherein Y represents hydrogen atom or fluorine atom; when Y is hydrogen atom, one of Rf¹ and Rf² is —(CF₂CF₂)₃— and the other is —(CF₂CF₂)₂— or —(CF₂CF₂)₃— and, when Y is fluorine atom, Rf¹ and Rf² are the same or different and each is a divalent hydrocarbon group containing 1 to 4 carbon atoms and containing at least one fluorine atom; m and n are the same or different and each represents an integer of 1 to 3; and M represents NH₄, Li, Na, K or H.

The present invention is a method of producing a fluoropolymer, which comprises producing the fluoropolymer by carrying out a polymerization in an aqueous medium in the presence of the above-mentioned surfactant.

The present invention is a fluoropolymer aqueous dispersion, wherein a particle comprising a fluoropolymer is dispersed in an aqueous medium in the presence of the above-mentioned surfactant.

### DETAILED DISCLOSURE OF THE INVENTION

The surfactant of the invention is suited for use as a dispersant to be present in an aqueous medium in producing a fluoropolymer by polymerization in the aqueous medium and makes it possible to obtain particles comprising a fluoropolymer in an aqueous dispersion obtained by polymerization at a size smaller in diameter as compared with the use of the conventional surfactants.

The term “aqueous dispersion” as used herein is a dispersion wherein particles comprising a fluoropolymer obtained by radical polymerization are dispersed in an aqueous medium. The aqueous dispersion may be one having a fluoropolymer concentration in the aqueous dispersion as substantially modified, for example by such a procedure as dilution or concentration, in the presence of the surfactant of the invention. In some instances, such a procedure as concentration as mentioned above may result in flocculation of particles comprising a fluoropolymer (primary particles) in the aqueous dispersion to form particles increased in particle diameter (secondary particles). The particle diameter, so referred to herein with regard to the particles comprising a fluoropolymer in the aqueous dispersion, is the diameter of the above-mentioned primary particles.

The term “aqueous medium” as used herein referring to the surfactant of the invention and to the method of producing a fluoropolymer according to the invention, which is to be described later herein, means a water-containing liquid serving as a reaction medium for carrying out the polymerization. The aqueous medium is not particularly restricted but may be any water-containing one. Thus, it may comprise water and, for example, a fluorine-free organic solvent such as an alcohol, ether or ketone and/or a fluorine-containing organic solvent having a boiling point of not higher than 40° C. In the case of suspension polymerization, for instance, such a fluorine-containing organic solvent as C318 can be used.

The “fluoropolymer” so referred to herein is a polymer containing carbon-bound fluorine atoms. In accordance with the invention, the fluoropolymer is obtained by polymerizing one or more fluorine-containing monomers and may also be one obtained by copolymerization with a fluorine-free monomer containing no fluorine atoms. The fluorine-containing monomer is a monomer containing at least one carbon-bound fluorine atom. The particulars of the fluoropolymer are described later herein.

The surfactant of the invention comprises a fluorine-containing-sulfobutanedioic-acid-ester derivative represented by the general formula (i) given hereinabove. By using the fluorine-containing-sulfobutanedioic-acid-ester derivative, it becomes possible to obtain particles comprising a fluoropolymer in an aqueous dispersion obtained by polymerization at a size smaller in diameter as compared with the use of the conventional surfactants. The surfactant of the invention may comprise one or more species of the fluorine-containing-sulfobutanedioic-acid-ester derivative mentioned above.

In the above general formula (i), M represents NH₄, Li, Na, K or H.

From the viewpoint that the surfactant can be removed from the fluoropolymer formed with ease by heating treatment, NH₄ is preferred as M while, from the emulsifying ability or dispersing ability viewpoint, Li, Na and K are preferred.

In the above general formula (i), m and n are the same or different and each represents an integer of 1 to 3. When the integer is greater than 3, the extent of chain transfer on the occasion of polymerization becomes excessive, leading to failure to obtain high-molecular-weight fluoropolymers. Preferably, m and n are the same or different and each is an integer of 1 or 2 and, more preferably, they are the same and equal to 1 or 2.

In the above general formula (i), Y represents hydrogen or fluorine atom.

When Y in the above general formula (i) is hydrogen atom, one of Rf¹ and Rf² is —(CF₂CF₂)₃— and the other is —(CF₂CF₂)₂— or —(CF₂CF₂)₃—.

When Y is hydrogen atom and one of Rf¹ and Rf² is —(CF₂CF₂)₃— and the other is —(CF₂CF₂)₃—, the corresponding fluorine-containing-sulfobutanedioic-acid-ester derivative makes it possible to obtain particles comprising a fluoropolymer having a smaller particle diameter as contained in the aqueous dispersion obtained by polymerization than in the case of using the conventional sulfobutanedioic-acid-ester derivatives having H—(CF₂CF₂)₂— at each end.

When, in the above general formula (i), Y is hydrogen atom, it is preferred that one of Rf¹ and Rf² be —(CF₂CF₂)₃— and the other —(CF₂CF₂)₂—. In this case, the sulfobutanedioic-acid-ester derivative makes it possible to obtain particles comprising a fluoropolymer having a small particle diameter as contained in the aqueous dispersion obtained by polymerization and, at the same time, has an appropriate level of water solubility while maintaining the surfactant activity.

When Y is hydrogen atom in the above general formula (i), it is preferred that m and n both be equal to 1. The fluorine-containing-sulfobutanedioic-acid-ester derivative, which has H—(CF₂CF₂)₃—CH₂—O— at each end or H—(CF₂CF₂)₃—CH₂—O— at one end and H—(CF₂CF₂)₂—CH₂—O— at the other end, has a reduced level of chain transfer activity and thus makes it possible to produce high-molecular-weight fluoropolymers and, further, makes it possible to obtain particles comprising a fluoropolymer smaller in particle diameter as contained in the aqueous dispersion obtained by polymerization than with the conventional surfactants.

Preferred as the fluorine-containing-sulfobutanedioic-acid-ester derivative in which Y is hydrogen atom is H(CF₂CF₂)₃CH₂OCOCH(SO₃Na)CH₂COOCH₂(CF₂CF₂)₃H (hereinafter sometimes referred to as “fluorine-containing-sulfobutanedioic-acid-ester derivative (a)”), since it makes it possible to obtain those particles comprising a fluoropolymer in the aqueous dispersion obtained by polymerization which are smaller in particle diameter as compared with the conventional surfactants. More preferred from the adequate water solubility viewpoint are those of the formula H(CF₂CF₂)₃—(CH₂)ₘ—OCOCH(SO₃M)CH₂COO—(CH₂)ₙ—(CF₂CF₂)₂H (m, n and M being as defined above; hereinafter sometimes referred to as “fluorine-containing-sulfobutanedioic-acid-ester derivatives (b)”). Preferred among the fluorine-containing-sulfobutanedioic-acid-ester derivatives (b) is H(CF₂CF₂)₃CH₂OCOCH(SO₃Na)CH₂COOCH₂(CF₂CF₂)₂H (hereinafter sometimes referred to as “fluorine-containing-sulfobutanedioic-acid-ester derivative (b1)”).

The surfactant of the invention, when it comprises a fluorine-containing-sulfobutanedioic-acid-ester derivative in which Y in the above formula (i) is a hydrogen atom, preferably the fluorine-containing-sulfobutanedioic-acid-ester derivative (a) and/or the fluorine-containing-sulfobutanedioic-acid-ester derivative (b1), may contain H(CF₂CF₂)₂—(CH₂)ₘ—OCOCH(SO₃M)CH₂COO—(CH₂)ₙ—(CF₂CF₂)₂H (m, n and M being as defined above), preferably H(CF₂CF₂)₂—CH₂OCOCH(SO₃Na)CH₂COOCH₂(CF₂CF₂)₂H.

The surfactant mentioned above, when it contains a fluorine-containing-sulfobutanedioic-acid-ester derivative in which Y in the above formula (i) is hydrogen atom, preferably comprises a molecular assembly as represented by the general formula (ii):
H(CF₂CF₂)ₐCH₂OCOCH(SO₃Na)CH₂COOCH₂(CF₂CF₂)_{b}H (ii)
wherein the average of a and the average of b are 2.05 to 2.95, since it is possible to obtain particles comprising a fluoropolymer smaller in particle diameter as contained in the aqueous dispersion obtained by polymerization than with the conventional surfactants. A preferred lower limit to the average of a and the average of b is 2.2, and a preferred upper limit thereto is 2.5. The average of a and the average of b are values determined for an assembly of molecules, and that assembly of molecules is an assembly of molecules which contains the fluorine-containing-sulfobutanedioic-acid-ester derivative (a) and fluorine-containing-sulfobutanedioic-acid-ester derivative (b1).

When Y is fluorine atom in the above general formula (i), Rf¹ and Rf² are the same or different and each is a divalent hydrocarbon group containing 1 to 4 carbon atoms and containing at least one fluorine atom. The “divalent hydrocarbon group”, so referred to herein, is a divalent group resulting from removal of two hydrogen atoms from a hydrocarbon. Alkylene groups are preferred as the divalent hydrocarbon group.

Preferred as the above-mentioned divalent hydrocarbon group containing 1 to 4 carbon atoms and containing at least one fluorine atom are divalent perfluorocarbon groups containing 1 to 4 carbon atoms. The “divalent perfluorocarbon group”, so referred to herein, is a divalent group resulting from removal of two hydrogen atoms from a perfluorocarbon.

The number of carbon atoms in the divalent hydrocarbon group is preferably 3 or 4, more preferably 4.

When Y is fluorine atom, Rf¹ and Rf² are preferably the same and each is a divalent perfluorocarbon group containing 1 to 4 carbon atoms and, more preferably, they are the same and each is a divalent perfluorocarbon group containing 3 or 4 carbon atoms. Still more preferably, they are the same and each is a perfluorotetramethylene group.

When Y is fluorine atom in the above general formula (i), both m and n are preferably equal to 2. When Y is fluorine atom and it has F—Rf¹—(CH₂)₂—O— and F—Rf²—(CH₂)₂—O respectively at both ends, the fluorine-containing-sulfobutanedioic-acid-ester derivative renders it possible to produce high-molecular-weight fluoropolymers and, furthermore, makes it possible for the fluoropolymer particles in the aqueous dispersion obtained by polymerization to have a smaller particle size as compared with the use of the conventional surfactants.

Preferred as the fluorine-containing-sulfobutanedioic-acid-ester derivative having fluorine atom for Y is F(CF₂CF₂)₂CH₂CH₂OCOCH(SO₃Na)CH₂COOCH₂CH₂(CF₂CF₂)₂F (hereinafter sometimes referred to as “fluorine-containing-sulfobutanedioic-acid-ester derivative (c)”), since it makes it possible to obtain particles comprising a fluoropolymer smaller in particle diameter as contained in the aqueous dispersion obtained by polymerization as compared with the use of the conventional surfactants.

The fluorine-containing-sulfobutanedioic-acid-ester derivative in the surfactant of the invention preferably comprises H(CF₂CF₂)₃CH₂OCOCH(SO₃Na)CH₂COOCH₂(CF₂CF₂)₂H, H(CF₂CF₂)₃CH₂OCOCH(SO₃Na)CH₂COOCH₂(CF₂CF₂)₃H and/or F(CF₂CF₂)₂CH₂CH₂OCOCH(SO₃Na)CH₂COOCH₂CH₂(CF₂CF₂)₂F. All of these three derivatives may be used in combination. From the dispersing ability viewpoint, however, the use of any one of them is sufficient. In view of the fact that particles comprising a fluoropolymer in the aqueous dispersion obtained by polymerization are obtained at a smaller particle diameter than the use of the conventional surfactants, the former two, namely the fluorine-containing-sulfobutanedioic-acid-ester derivative (b1) and fluorine-containing-sulfobutanedioic-acid-ester derivative (a), are preferred and, in view of its having an adequate level of solubility in water, the fluorine-containing-sulfobutanedioic-acid-ester derivative (b1) is more preferred.

As for the method of producing the fluorine-containing-sulfobutanedioic-acid-ester derivative for use as or in the surfactant of the invention, mention may be made of, for example, the method comprising adding a sulfite compound to a fluorine-containing maleic acid diester compound obtained by boiling, under reflux, a fluorine-containing alcohol represented by Y—Rf¹—(CH₂)ₘ—OH, a fluorine-containing alcohol represented by Y—Rf²—(CH₂)ₙ—OH (Y, m, n, Rf¹ and Rf² being as defined above) and maleic anhydride for about 18 to 24 hours, and boiling the resulting mixture under reflux for a few days, preferably for about 3 days to give the corresponding fluorine-containing-sulfobutanedioic-acid-ester derivative.

Even when it comprises the above-mentioned fluorine-containing-sulfobutanedioic-acid-ester derivative alone, the surfactant of the invention can satisfactorily function as a surfactant in polymerization processes. If desirable, however, the surfactant may comprise, in addition to the fluorine-containing-sulfobutanedioic-acid-ester derivative, another compound having surfactant activity.

The other compound having surfactant activity is not particularly restricted but may be any of surfactants of the anionic, cationic, nonionic or betaine type, for instance. Those surfactants may be hydrocarbon-based ones.

The surfactant of the invention may further comprise, in addition to the fluorine-containing-sulfobutanedioic-acid-ester derivative and the other compound having surfactant activity as optionally employed as desired, one or more additives. The additives are not particularly restricted but may be those generally used in conventional surfactants, for example stabilizers.

The surfactant of the invention can be suitably used as a surfactant for polymerization for producing a fluoropolymer and, further, can be adequately used as a dispersant for dispersing a fluoropolymer obtained by polymerization in an aqueous medium.

When the surfactant of the invention is used as a dispersant for dispersing a fluoropolymer obtained by polymerization in an aqueous medium, the fluorine-containing-sulfobutanedioic-acid-ester derivative has a good balance between affinity for the fluoropolymer and affinity for the aqueous medium and therefore the surfactant can show its excellent dispersing ability, like in the case of the above-mentioned use as a surfactant for polymerization.

The method of producing a fluoropolymer according to the invention comprises carrying out a polymerization in an aqueous medium in the presence of the surfactant of the invention to produce the fluoropolymer.

The method of polymerization in carrying out the method of producing a fluoropolymer according to the invention is a conventional one except that the surfactant of the invention is used as the surfactant for polymerization to be used in polymerizing a fluorine-containing monomer or monomers.

In carrying out the method of producing a fluoropolymer according to the invention, the polymerization is carried out by charging a polymerization reaction vessel with water, the surfactant and a monomer or monomers, optionally together with another additive or other additives, stirring the contents of the reaction vessel, maintaining the reaction vessel at a predetermined temperature, and then adding a predetermined amount of a polymerization initiator to initiate the polymerization reaction. After the initiation of the polymerization reaction, further amounts of a monomer(s), initiator, chain transfer agent and surfactant may be added.

In the above polymerization, the polymerization temperature is generally 5 to 120° C., and the polymerization pressure is generally 0.05 to 10 MPaG. The polymerization temperature and polymerization pressure are to be adequately selected according to the monomer species employed, the molecular weight of the desired polymer, and the rate of reaction.

The above surfactant is preferably added in a total amount of 0.0001 to 15% by mass relative to the aqueous medium. A more preferred lower limit is 0.001% by mass, and a more preferred upper limit is 10% by mass and a still more preferred upper limit is 1% by mass. When the amount is less than 0.0001% by mass, the dispersing powder tends to be insufficient and, at addition levels exceeding 15% by mass, the effects of the addition will be no more proportional to the addition level and rather may cause a decrease in rate of polymerization or a termination reaction. The level of addition of the surfactant is to be adequately selected according to the monomer species employed, the molecular weight of the desired product and other factors. In carrying out the above production method, another surfactant may also be used so long as the surfactant of the invention is used.

The polymerization initiator is not particularly restricted but may be any of those capable of generating a radical within the polymerization temperature range mentioned above, including known oil-soluble and/or water-soluble polymerization initiators. Furthermore, the polymerization can also be initiated in a redox system constructed by combined use of a reducing agent, for instance. The concentration of the polymerization initiator is to be adequately selected according to the monomer species, the molecular weight of the desired polymer, and the rate of reaction.

In the above polymerization, it is also possible to adjust the rate of polymerization and the molecular weight by adding any of the known chain transfer agents or radical scavengers according to the intended purpose.

The fluoropolymer mentioned above is one obtained by polymerizing a fluorine-containing monomer or monomers and, according to the intended purpose, a fluorine-free monomer or monomers may be copolymerized.

The fluorine-containing monomer is, for example, a fluoroolefin, preferably a fluoroolefin containing 2 to 10 carbon atoms; a cyclic fluorinated monomer; or a fluorinated alkyl vinyl ether represented by the formula CY₂═CYOR or CY₂═CYOR¹OR (in which Y is H or F, R is an alkyl group containing 1 to 8 carbon atoms as resulting from partial or total substitution of the hydrogen atoms by a fluorine atom or atoms, and R¹ is an alkylene group containing 1 to 8 carbon atoms as resulting from partial or total substitution of the hydrogen atoms by a fluorine atom or atoms).

The fluoroolefin preferably contains 2 to 6 carbon atoms. The fluoroolefin containing 2 to 6 carbon atoms includes, among others, tetrafluoroethylene [TFE], hexafluoropropylene [HFP], chlorotrifluoroethylene [CTFE], vinyl fluoride, vinylidene fluoride [VDF], trifluoroethylene, hexafluoroisobutylene and perfluorobutylethylene. As preferred examples of the cyclic fluorinated monomer, there may be mentioned perfluoro-2,2-dimethyl-1,3-dioxole [PDD] and perfluoro-2-methylene-4-methyl-1,3-dioxolane [PMD], among others.

Referring to the fluorinated alkyl vinyl ether, the group R preferably contains 1 to 4 carbon atoms and more preferably is one resulting from substitution of all hydrogen atoms by fluorine atoms, and the group R¹ preferably contains 2 to 4 carbon atoms and more preferably is one resulting from substitution of all hydrogen atoms by fluorine atoms.

The fluorine-free monomer is, for example, a hydrocarbon-based monomer reactive with the fluorine-containing monomer(s) mentioned above. As the hydrocarbon-based monomer, there may be mentioned, for example, alkenes such as ethylene, propylene, butylenes and isobutylene; alkyl vinyl ethers such as ethyl vinyl ether, propyl vinyl ether, butyl vinyl ether, isobutyl vinyl ether and cyclohexyl vinyl ether; vinyl esters, such as vinyl acetate, vinyl propionate, vinyl n-butyrate, vinyl isobutyrate, vinyl valerate, vinyl pivalate, vinyl caproate, vinyl caprylate, vinyl caprate, vinyl versatate, vinyl laurate, vinyl myristate, vinyl palmitate, vinyl stearate, vinyl benzoate, vinyl p-tert-butylbenzoate, vinyl cyclohexanecarboxylate, vinyl monochloroacetate, vinyl adipate, vinyl acrylate, vinyl methacrylate, vinyl crotonate, vinyl sorbate, vinyl cinnamate, vinyl undecylenate, vinyl hydroxyacetate, vinyl hydroxypropionate, vinyl hydroxybutyrate, vinyl hydroxyvalerate, vinyl hydroxyisobutyrate and vinyl hydroxycyclohexanecarboxylate; alkyl allyl ethers such as ethyl allyl ether, propyl allyl ether, butyl allyl ether, isobutyl allyl ether and cyclohexyl allyl ether; and alkyl allyl esters such as allyl acetate, allyl propionate, allyl n-butyrate, allyl isobutyrate and allyl cyclohexanecarboxylate.

The fluorine-free monomer may also be a functional group-containing, hydrocarbon-based monomer. As the functional group-containing, hydrocarbon-based monomer, there may be mentioned, for example, hydroxyalkyl vinyl ethers such as hydroxyethyl vinyl ether, hydroxypropyl vinyl ether, hydroxybutyl vinyl ether, hydroxyisobutyl vinyl ether and hydroxycyclohexyl vinyl ether; carboxyl group-containing, fluorine-free monomers such as itaconic acid, succinic acid, succinic anhydride, fumaric acid, fumaric anhydride, crotonic acid, maleic acid and maleic anhydride; glycidyl group-containing, fluorine-free monomers such as glycidyl vinyl ether and glycidyl allyl ether; amino group-containing, fluorine-free monomers such as aminoalkyl vinyl ethers and aminoalkyl allyl ethers; and amide group-containing, fluorine-free monomers such as (meth)acrylamide and methylolacrylamide.

As examples of the fluoropolymer which can be advantageously produced by the production method of the invention, there may be mentioned a TFE polymer in which the monomer whose mole fraction in the polymer is highest (hereinafter “most abundant monomer”) is TFE, a VDF polymer in which the most abundant monomer is VDF, and a CTFE polymer in which the most abundant monomer is CTFE.

The TFE polymer may adequately be a TFE homopolymer or a copolymer derived from (1) TFE, (2) one or more fluorine-containing monomers other than TFE which contain 2 to 8 carbon atoms and (3) some other monomer. The other monomer may be, for example, a fluoro(alkyl vinyl ether) having an alkyl group containing 1 to 5 carbon atoms, in particular 1 to 3 carbon atoms; a fluorodioxole; a perfluoroalkylethylene; or an ω-hydroperfluoroolefin.

The TFE polymer may also be a copolymer of TFE and one or more fluorine-free monomers. As the fluorine-free monomers, there may be mentioned, for example, alkenes such as ethylene and propylene vinyl esters; and vinyl ethers. The TFE polymer may further be a copolymer of TFE, one or more fluorine-containing monomers containing 2 to 8 carbon atoms, and one or more fluorine-free monomers.

The VDF polymer may adequately be a VDF homopolymer [PVDF] or a copolymer comprising (1) VDF, (2) one or more fluoroolefins other than VDF which contain 2 to 8 carbon atoms, in particular TFE, HFP or CTFE, and (3) a perfluoro(alkyl vinyl ether) having an alkyl group containing 1 to 5 carbon atoms, in particular 1 to 3 carbon atoms.

The CTFE polymer may adequately be a CTFE homopolymer or a copolymer of (1) CTFE, (2) one or more fluoroolefins other than CTFE which contain 2 to 8 carbon atoms, in particular TFE or HFP, and (3) a perfluoro(alkyl vinyl ether) having an alkyl group containing 1 to 5 carbon atoms, in particular 1 to 3 carbon atoms.

The CTFE polymer may also be a copolymer of CTFE and one or more fluorine-free monomers and, as the fluorine-free monomers, there may be mentioned alkenes such as ethylene and propylene: vinyl esters; and vinyl ethers, among others.

The fluoropolymer produced by the production method of the invention may be glass-like, plastic or elastomeric. These forms are either noncrsytalline or partially crystalline and can be subjected to compression sintering molding, melt processing or non-melt processing.

Appropriately producible by the production method of the invention are, for example, (I) polytetrafluoroethylene [PTFE] as a non-melt-processable resin, (II) ethylene/TFE copolymers [ETFEs], TFE/HFP copolymers [FEPs] and TFE/perfluoro(alkyl vinyl ether) copolymers [PFA, MFA, etc.] as melt-processable resins, and (III) such elastomeric polymers as TFE/propylene copolymers, TFE/propylene/third monomer copolymers (the third monomer being, for example, VDF, HFP, CTFE or a perfluoro(alkyl vinyl ether)), TFE/perfluoro(alkyl vinyl ether) copolymers; HFP/ethylene copolymers, HFP/ethylene/TFE copolymers; PVDF; VDF/HFP copolymers, VDF/TFE/HFP copolymers and like thermoplastic elastomers; and fluorine-containing segmented polymers described in Japanese Patent Publication (Kokoku) S61-49327.

The perfluoro(alkyl vinyl ether) mentioned above is represented by the formula: 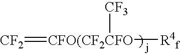
wherein Rf⁴ is a perfluoroalkyl group containing 1 to 6 carbon atoms; and j is an integer of 0 to 5.

The above-mentioned (I) non-melt processable resins, (II) melt-processable resins and (III) elastomeric polymers to be suitably produced by the production method of the invention are preferably produced in the following manner.

(I) Non-Melt-Processable Resins

The polymerization for PTFE production according to the production method of the invention is generally carried out at a polymerization temperature of 10 to 100° C. and at a polymerization pressure of 0.05 to 5 MPaG.

In carrying out the above polymerization, a pressure reaction vessel equipped with a stirrer is charged, after deoxygenation, with TFE, the temperature is adjusted to a predetermined level, and a polymerization initiator is added to initiate the reaction. Since otherwise the pressure decreases with the progress of the reaction, TFE is additionally fed to the reactor continuously or intermittently so that the initial pressure may be maintained. At the time of arrival of the amount of TFE fed at a predetermined level, the feeding is stopped, the TFE remaining within the reactor is purged off, and the temperature is returned to room temperature to terminate the reaction.

In the above-mentioned PTFE production, any of various known modifier monomers can be used. The term “polytetrafluoroethylene [PTFE]” as used herein conceptually includes not only TFE homopolymers but also non-melt-processable copolymers of TFE and a modifier monomer(s) (hereinafter also referred to as “modified PTFEs”).

As the modifier monomer, there may be mentioned, for example, perhaloolefins such as HFP and CTFE; fluoro(alkyl vinyl ethers) having an alkyl group containing 1 to 5 carbon atoms, in particular 1 to 3 carbon atoms; cyclic fluorinated monomers such as fluorodioxoles; perhaloalkylethylenes; and ω-hydroperhaloolefins.

The modifier monomer can be fed all at once initially or continuously or in divided portions intermittently according to the intended purpose and/or the manner of feeding of TFE.

The modifier monomer content in the modified PTFEs is generally within the range of 0.001 to 2 mole percent.

In the above PTFE production, the surfactant of the invention can be used in the usage range described hereinabove referring to the method of producing a fluoropolymer according to the invention and, generally, is added in an amount of 0.0001 to 5% by mass relative to the aqueous medium. The surfactant concentration is not particularly restricted provided that it is within the above range. Generally, however, the surfactant is added at a level not higher than the critical micelle concentration (CMC) at the time of initiation of the polymerization. At excessive addition levels, needle crystals having a high aspect ratio are formed and the aqueous dispersion becomes gel-like, hence the stability is threatened.

As for the polymerization initiator in the above PTFE production, persulfate salts (e.g. ammonium persulfate) or organic peroxides such as disuccinoyl peroxide and diglutaroyl peroxide can be used either singly or in the form of a mixture of these. Redox systems resulting from combined use of a reducing agent such as sodium sulfite may also be used. Further, it is also possible to adjust the radical concentration in the system during polymerization by adding such a radical scavenger as hydroquinone or catechol, or by adding such a peroxide decomposer as ammonium sulfite.

In the above PTFE production, the chain transfer agent to be used may be any of those known in the art, including, among others, saturated hydrocarbons such as methane, ethane, propane and butane, halogenated hydrocarbons such as chloromethane, dichloromethane and difluoroethane, alcohols such as methanol and ethanol, and water. Those which are gaseous at ordinary temperature and ordinary pressure are preferred, however.

The chain transfer agent is generally used in an amount of 1 to 1000 ppm, preferably 1 to 500 ppm, relative to the total feed amount of TFE.

In the above PTFE production, a saturated hydrocarbon which is substantially inert to the reaction and contains 12 or more carbon atoms and takes the form of a liquid under the reaction conditions mentioned above can be used as a dispersion stabilizer for the reaction system in an amount of 2 to 10 parts by mass per 100 parts by mass of the aqueous medium. Further, ammonium carbonate, ammonium phosphate or the like may be added as a buffering agent for adjusting the pH during reaction.

At the time of completion of the PTFE polymerization mentioned above, an aqueous dispersion having a solid matter concentration of 10 to 40% by mass and containing fine PTFE particles with an average particle diameter of 0.05 to 5000 μm, in particular not greater than 0.2 μm when the surfactant of the invention is used, can be obtained. The PTFE after completion of the above polymerization has a number average molecular weight of 1,000 to 10,000,000.

The above-mentioned aqueous dispersion of PTFE is subjected to flocculation/coagulation and drying and the resulting fine powder can be used in various fields of application.

In subjecting the above aqueous dispersion of PTFE to flocculation/coagulation, the aqueous dispersion, for example a polymer latex, as obtained by emulsion polymerization is generally diluted to a polymer concentration of 10 to 20% by mass with water and, after pH adjustment to neutrality or alkalinity according to need, the dilution is stirred in a vessel equipped with a stirrer more vigorously than during reaction. The flocculation/coagulation may also be carried out while adding, as a flocculant/coagulant, a water-soluble organic compound such as methanol or acetone, an inorganic salt such as potassium nitrate or ammonium carbonate or an inorganic acid such as hydrochloric acid, sulfuric acid or nitric acid. The flocculation/coagulation may also be carried out continuously using an inline mixer or the like.

When one or more pigments for coloration and/or one or more of various fillers for mechanical properties improvement are added before or during the above flocculation/coagulation, pigment- and/or filler-containing PTFE fine powders with the pigment(s) and/or filler(s) uniformly incorporated therein can be obtained.

The wet powder obtained by flocculation/coagulation of the above PTFE aqueous dispersion is generally dried using such means as vacuum, high-frequency or hot air while maintaining the wet powder in a condition not so fluidized, preferably in a stationary condition. Generally, friction among particles, in particular at elevated temperatures, unfavorably affects the PTFE in a fine powder form. This is because particles of this type of PTFE have properties such that, even upon exposure to a slight shearing force, they are readily fibrillated, with the loss of their original condition showing a stable particle structure.

The above drying is carried out at a drying temperature of 10 to 250° C., preferably 100 to 200° C.

The PTFE fine powder obtained is preferred for molding purposes and, as suitable fields of application, there may be mentioned tubes or the like for use in hydraulic systems and fuel systems in aircrafts, automobiles and so forth and, further, flexible hoses for the transfer of liquid chemicals, vapor and the like, and electric wire coatings, among others.

The PTFE aqueous dispersion obtained by the above polymerization is also preferably stabilized by addition of a nonionic surfactant and then further concentrated for use in various applications in the form of a composition supplemented with an inorganic or organic filler according to the intended purpose. Such composition, when applied onto a substrate made of a metal or ceramic, can provide a coat surface which is non-sticky and low in coefficient of friction and excellent in luster, smoothness, wear resistance, weather resistance and heat resistance and, thus, the composition is suited for coating rolls, cooking utensils and the like and for impregnation of glass cloths therewith, for instance.

(II) Melt-Processable Resins

(1) The polymerization for FEP production according to the production method of the invention is preferably carried out generally at a polymerization temperature of 60 to 100° C. and a polymerization pressure of 0.7 to 4.5 MPaG.

The monomer composition TFE:HFP for the FEP is (60 to 95):(5 to 40), more preferably (85 to 90):(10 to 15). The FEP may also be one modified with a perfluoro(alkyl vinyl ether) used as a third component within the range of 0.5 to 2% by mass on the whole monomer basis.

In the above polymerization for FEP production, the above-mentioned surfactant of the invention can be used within the usage range in carrying out the production method of the invention. Generally, the surfactant is added in an amount of 0.0001 to 5% by mass relative to the aqueous medium.

In the above polymerization for FEP production, such a chain transfer agent as cyclohexane, methanol, ethanol, carbon tetrachloride, chloroform, methylene chloride or methyl chloride is preferably used, and such a pH buffering agent as ammonium carbonate or disodium hydrogen phosphate is preferably used.

(2) The polymerization for producing a TFE/perfluoro(alkyl vinyl ether) copolymer, such as PFA or MFA, according to the production method of the invention is preferably carried out generally at a polymerization temperature of 60 to 100° C. and a polymerization pressure of 0.7 to 2.5 MPaG.

The monomer composition (mole percent), TFE:perfluoro(vinyl alkyl ether), of the TFE/perfluoro(alkyl vinyl ether) copolymer is preferably (95 to 99.7):(0.3 to 5), more preferably (98 to 99.5):(0.5 to 2). The perfluoro(alkyl vinyl ether) to be used is preferably one represented by the formula: CF₂═CFORf (in which Rf is a perfluoroalkyl group containing 1 to 6 carbon atoms).

In the above polymerization for TFE/perfluoro(alkyl vinyl ether) copolymer production, the surfactant of the invention can be used within the usage range in carrying out the production method of the invention. Generally, the surfactant is added in an amount of 0.0001 to 2% by mass relative to the aqueous medium.

In the above polymerization for TFE/perfluoro(alkyl vinyl ether) copolymer production, such a chain transfer agent as cyclohexane, methanol, ethanol, carbon tetrachloride, chloroform, methylene chloride, methyl chloride, methane or ethane is preferably used, and such a pH buffering agent as ammonium carbonate or disodium hydrogen phosphate is preferably used.

(3) The polymerization for ETFE production according to the production method of the invention is preferably carried out generally at a polymerization temperature of 20 to 100° C. and a polymerization pressure of 0.5 to 0.8 MPaG.

The monomer composition (mole percent), TFE:ethylene, of the ETFE is preferably (50 to 99):(50 to 1). The ETFE may also be one modified with a third monomer within the range of 0 to 20% by mass based on the whole monomer basis. Preferred is a composition within the range of TFE:ethylene:third monomer=(45 to 95):(45 to 1):(4 to 10). Preferred as the third monomer are perfluorobutylethylene, 2,3,3,4,4,5,5-heptafluoro-1-pentene (CH₂═CFCF₂CF₂CF₂H) and 2-trifluoromethyl-3,3,3-trifluoropropene ((CF₃)₂C═CH₂).

In the above polymerization for ETFE production, the surfactant of the invention can be used within the usage range in carrying out the production method of the invention. Generally, the surfactant is added in an amount of 0.0001 to 2% by mass relative to the aqueous medium.

In the above polymerization for ETFE production, such a chain transfer agent as cyclohexane, methanol, ethanol, carbon tetrachloride, chloroform, methylene chloride or methyl chloride is preferably used.

(III) Elastomeric Polymers

In carrying out the polymerization for elastomeric polymer production according to the production method of the invention, a pressure reaction vessel equipped with a stirrer is charged, after deoxygenation, with the monomers, the temperature is adjusted to a predetermined level, and a polymerization initiator is then added to initiate the polymerization. Since otherwise the pressure decreases with the progress of the reaction, the monomers are additionally fed to the reactor continuously or intermittently so that the initial pressure may be maintained. At the time of arrival of the amounts of the monomers fed at predetermined levels, the feeding is stopped, the monomers remaining in the reactor is purged off, and the temperature is returned to room temperature to terminate the reaction. In the case of emulsion polymerization, the resulting polymer latex is preferably taken out of the reactor continuously.

In the case of producing a thermoplastic elastomer, in particular, it is possible to increase the final rate of polymerization as compared with ordinary polymerization processes by once synthesizing fine polymer particles at a high surfactant concentration and then, after dilution, further carrying out the polymerization, as disclosed in WO 00/01741.

In carrying out the above polymerization for elastomeric polymer production, the conditions are to be properly selected according to the physical properties of the desired polymer and from the polymerization rate control viewpoint. The polymerization temperature is generally −20 to 200° C., preferably 5 to 150° C., and the polymerization pressure is generally 0.5 to 10 MPaG, preferably 1 to 7 MPaG, however. The pH in the polymerization medium is preferably maintained generally within the range of 2.5 to 9 using a pH adjusting agent, which is mentioned later herein.

As the monomers to be used in the above-mentioned polymerization for elastomeric polymer production, there may be mentioned, in addition to vinylidene fluoride, those fluorine-containing, ethylenically unsaturated monomers which contain at least the same number of fluorine atoms as the number of carbon atoms contained therein and are copolymerizable with vinylidene fluoride. As the fluorine-containing, ethylenically unsaturated monomers, there may be mentioned trifluoropropene, pentafluoropropene, hexafluorobutene and octafluorobutene. Among them, hexafluoropropene is particularly preferred in view of the elastomer characteristics attainable when it inhibits the growth of polymer crystals. Further, trifluoroethylene, TFE and CTFE, for instance, may also be mentioned as the fluorine-containing ethylenically unsaturated monomer, and fluorine-containing monomers having one or more chlorine and/or bromine substituents may also be used. Also usable are perfluoro(alkyl vinyl ether) species, for example perfluoro(methyl vinyl ether). TFE and HFP are preferred in producing elastomeric polymers.

The monomer composition (% by mass) of the elastomeric polymer, vinylidene fluoride:HFP:TFE, is preferably (20 to 70):(20 to 60):(0 to 40). When it has such a composition, the elastomeric polymer shows good elastomer characteristics, chemical resistance and thermal stability.

In carrying out the above-mentioned polymerization for elastomeric polymer production, the surfactant of the invention can be used within the usage range in carrying out the production method of the invention. Generally, the surfactant is added in an amount of 0.0001 to 5% by mass relative to the aqueous medium.

As for the polymerization initiator for use in the above-mentioned polymerization for elastomeric polymer production, any known inorganic radical polymerization initiator can be used. Particularly useful as the inorganic radical polymerization initiator are those water-soluble inorganic peroxides which are known in the art, for example, sodium, potassium and ammonium persulfate, perphosphate, perborate, percarbonate or permanganate. The above-mentioned radical polymerization initiator can be further activated by a reducing agent, such as a sodium, potassium or ammonium sulfite, bisulfite, metabisulfite, hyposulfite, thiosulfate, phosphite or hypophosphite, or by a readily oxidizable metal compound, such as a ferrous salt, cuprous salt or silver salt. Ammonium persulfate is preferred as the inorganic radical polymerization initiator, and the combined use of ammonium persulfate and sodium bisulfite to establish a redox system is more preferred.

The level of addition of the polymerization initiator should be properly selected according to the molecular weight of the desired polymer and the rate of polymerization reaction. Generally, it is set at 0.0001 to 10% by mass, preferably 0.01 to 5% by mass, on the whole monomer basis.

The chain transfer agent to be used in the above-mentioned polymerization for elastomeric polymer production may be any of known ones. In the case of polymerization for PVDF production, hydrocarbons, esters, ethers, alcohols, ketones, chlorine compounds and carbonates, among others, can be used and, in the case of thermoplastic elastomer production, hydrocarbons, esters, ethers, alcohols, chlorine compounds and iodine compounds, among others, can be used. For PVDF production by polymerization, acetone and isopropyl alcohol are preferred and, in the case of polymerization for thermoplastic elastomer production, isopentane, diethyl malonate and ethyl acetate are preferred from the viewpoint that the rate of reaction hardly falls, while diiodo compounds such as I(CF₂)₄I, I(CF₂)₆I and ICH₂I are preferred from the viewpoint that the polymer termini can be iodinated and the resulting polymer can be used as a reactive polymer. The usage of the chain transfer agent is generally 0.5×10³ to 5×10³ mole percent, preferably 1.0×10³ to 3.5×10³ mole percent, relative to the total amount of the monomers fed.

Referring to the above-mentioned polymerization for elastomeric polymer production, paraffin wax, for instance, can be preferably used as an emulsion stabilizer in the polymerization of PVDF production and, in the polymerization for elastomeric polymer production, a phosphate salt, sodium hydroxide or potassium hydroxide, for instance, can be preferably used as a pH-adjusting agent.

The elastomeric polymer obtained in accordance with the invention has, at the time of completion of the polymerization, a solid matter concentration of 10 to 40% by mass, an average particle diameter of 0.03 to 1 μm, preferably 0.05 to 0.5 μm, and a number average molecular weight of 1,000 to 2,000,000.

The elastomeric polymer obtained in accordance with the invention can be processed into a dispersion suited for rubber molding processing, for example by adding a dispersion stabilizer such as a hydrocarbon-based surfactant and concentration according to need. The dispersion is treated, for example by pH adjustment, flocculation/coagulation and heating. Each treatment is carried out in the following manner.

The pH adjustment comprises adding a mineral acid such as nitric acid, sulfuric acid, hydrochloric acid or phosphoric acid and/or a carboxylic acid containing not more than 5 carbon atoms and having a pK value of not higher than 4.2 to adjust the pH to 2 or below.

The flocculation/coagulation is carried out by adding an alkaline earth metal salt to the dispersion. The alkaline earth metal salt is, for example, calcium or magnesium nitrate, chlorate or acetate.

Either of the pH adjustment and flocculation/coagulation may be carried out first. Preferably, however, the pH adjustment is carried out first.

After each treatment procedure, the elastomer is washed with the same volume of water to remove such impurities as the buffer solution and salt remaining in small amounts in the elastomer, and then dried. The drying is generally carried out in a drying oven at about 70 to 200° C. while circulating air at elevated temperatures.

The method of producing a fluoropolymer according to the invention produces a fluoropolymer.

The fluoropolymer is generally obtained by carrying out the above-mentioned polymerization in the form of an aqueous dispersion with a concentration of 10 to 50% by mass. Since the fluoropolymer is obtained by carrying out the polymerization in the presence of the surfactant of the invention, the particles comprising the fluoropolymer in the aqueous dispersion obtained by polymerization can have a smaller particle diameter as compared with the use of the conventional surfactants. A preferred lower limit to the fluoropolymer concentration in the aqueous dispersion is 10% by mass, a more preferred lower limit is 15% by mass, and a preferred upper limit is 40% by mass, a more preferred upper limit is 35% by mass and a still more preferred upper limit is 30% by mass.

The aqueous dispersion obtained by carrying out the above-mentioned polymerization may be processed to a concentrated dispersion or a dispersion having been subjected to dispersion stabilization treatment, or may be subjected to flocculation or coagulation, followed by recovery and drying to give a powder or some other solid matter. While the method of producing a fluoropolymer according to the invention produces a fluoropolymer, the fluoropolymer produced may be a fluoropolymer dispersed in the above-mentioned aqueous dispersion or a fluoropolymer dispersed in the above-mentioned dispersion or a fluoropolymer in the form of the above-mentioned powder or some other solid matter.

The fluoropolymer aqueous dispersion of the invention is the dispersion wherein a particle comprising a fluoropolymer is dispersed in an aqueous medium in the presence of the above-mentioned surfactant.

The fluoropolymer aqueous dispersion of the invention may be an aqueous dispersion obtained by carrying out the above-mentioned polymerization, or a dispersion obtained by concentrating this aqueous dispersion or subjecting the same to dispersion stabilization treatment, or one obtained by dispersing a fluoropolymer powder in an aqueous medium in the presence of the above-mentioned surfactant.

The aqueous medium in the fluoropolymer aqueous dispersion of the invention is not particularly restricted provided that it contains water. Thus, it may contain such an organic solvent as a fluorine-free alcohol, ether or ketone, and/or such an organic solvent as dimethylformamide [DMF] or tetrahydrofuran [THF] and/or a fluorine-containing organic solvent having a boiling point of not higher than 40° C., or it may be organic solvent-free water. The aqueous medium in the polymerization, as such, may be used as the aqueous medium mentioned above. When the fluorine-containing-sulfobutanedioic-acid-ester derivative in the surfactant in the fluoropolymer aqueous dispersion of the invention has —SO₃M in the general formula (i) given hereinabove as occurring in the form of a salt, this salt may be ionically dissociated in the above-mentioned aqueous medium.

When the fluoropolymer aqueous dispersion of the invention is an aqueous dispersion obtained by carrying out the above-mentioned polymerization, the dispersion contains particles comprising the fluoropolymer having a number average particle diameter preferably within the range of about 0.05 to 1 μm, a more preferred upper limit to which is 0.5 μm, preferably at a concentration of about 10 to 70% by mass. A more preferred lower limit to that concentration is 15% by mass or above, and a more preferred upper limit is 60% by mass or below. On the other hand, when the fluoropolymer aqueous dispersion is the above-mentioned dispersion, it contains particles comprising the fluoropolymer preferably at a concentration of 30 to 50% by mass. The “number average particle diameter”, so referred to herein, when used for PTFE, is the value obtained, with a dilution as diluted to a solid matter concentration of the fluoropolymer obtained of about 0.02% by mass, based on a working curve showing the relation between the transmittance, per unit length, of incident light at 550 nm and the average particle diameter determined by electron photomicrography and, for other resins, is the average particle diameter determined by relative comparison with standard polystyrene species by electron photomicrography.

The above-mentioned surfactant of the invention is preferably used at a concentration of 0.0001 to 15% by mass based on the fluoropolymer aqueous dispersion of the invention. At concentrations lower than 0.0001% by mass, the dispersion stability may be poor in some instances and, at concentrations exceeding 15% by mass, the dispersing effect impractically becomes no more proportional to the amount of the surfactant present. A more preferred lower limit to the surfactant concentration is 0.001% by mass, and a preferred upper limit is 10% by mass and a more preferred upper limit is 2% by mass.

The aqueous dispersion obtained by carrying out the above-mentioned polymerization may also be concentrated or subjected to dispersion stabilization treatment to give a dispersion.

As for the method of concentration, any known method may be employed, and the aqueous dispersion can be concentrated to a fluoropolymer concentration of 40 to 60% by mass according to the intended use. In some cases, the stability of the dispersion may be impaired upon concentration and, in such cases, a dispersion stabilizer may further be added. The surfactant of the invention or one or more of various other surfactants may be added as the dispersion stabilizer(s). The other various dispersion stabilizers include, but are not limited to, nonionic surfactants such as polyoxyalkyl ethers, in particular polyoxyethylene ethers such as polyoxyethylene alkylphenyl ethers (e.g. Triton X-100™, product of Rohm & Haas Co.), polyoxyethylene isotridecyl ether (Dispanol TOC™, product of NOF Corporation) and polyoxyethylenepropyl tridecyl ether, in particular.

The total amount of the dispersion stabilizers is preferably 0.5 to 20% by mass relative to the solid matter in the dispersion. When it is smaller than 0.5% by mass, the dispersion stability may be poor in some instances and, when it exceeds 20% by mass, the dispersing effect impractically becomes no more proportional to the amount of the dispersion stabilizers present. A more preferred lower limit to the surfactant addition level is 2% by mass, and a more preferred upper limit is 12% by mass.

According to the intended use thereof, the aqueous dispersion obtained by carrying out the above-mentioned polymerization may also be treated for dispersion stabilization without concentration to prepare a fluoropolymer aqueous dispersion having a long pot life. As the dispersion stabilizer to be used, the same ones as mentioned above may be mentioned.

The use of the fluoropolymer aqueous dispersion of the invention is not particularly restricted but includes, among others, the use thereof in the aqueous dispersion form as such in coating processes comprising applying the same to substrates, followed by drying, if necessary further followed by sintering; in impregnation processes comprising impregnating porous supports, such as nonwoven fabrics or resin moldings, with the same, followed by drying, preferably further followed by sintering; and in cast-film formation, which comprises applying the same to a substrate such as glass, drying, immersing in water if necessary, and peeling the resulting thin film from the substrate. As examples of these applications, there may be mentioned water-based dispersion paints, electrode binders and electrode water repellents, among others.

The fluoropolymer aqueous dispersion of the invention can be used as a water-based paint for coating after incorporation of one or more of such ingredients as known pigments, thickening agents, dispersants, antifoamers, antifreezing agents and film-forming auxiliaries, or after combined use of another high-molecular compound to give a composite material.

As the use of the fluoropolymer aqueous dispersion of the invention, there may also be mentioned the use comprising utilization of the powder obtained by subjecting the fluoropolymer aqueous dispersion to coagulation or flocculation, recovering the resulting solid matter, and drying the same, if desirable followed by granulation. For the coagulation or flocculation, any of the methods known in the art can be employed as such. Thus, preferably employed are, for example, the method comprising adding a coagulant (flocculent) to the aqueous dispersion with stirring to thereby cause coagulation (flocculation), the method comprising freezing and thawing the aqueous dispersion to thereby cause coagulation (freeze coagulation method), the method comprising mechanically stirring the aqueous dispersion at a high speed to thereby cause coagulation (mechanical coagulation method), the method comprising spouting the aqueous dispersion through a narrow nozzle and simultaneously causing water to evaporate (spray coagulation method). If necessary, a coagulation auxiliary may be added. The drying may be effected by standing at room temperature or in a heated state up to 250° C. The powder obtained can be used, for example, as a molding material prepared by incorporation of a lubricating auxiliary and suited for paste extrusion molding, or as a powder coating composition, if desired after admixture of a pigment.

The surfactant of the invention, which comprises the fluorine-containing-sulfobutanedioic-acid-ester derivative mentioned above, renders it possible to obtain particles comprising a fluoropolymer in the aqueous dispersion obtained by polymerization with a smaller particle diameter as compared with the use of the conventional surfactant. The aqueous dispersion obtained by the above-mentioned polymerization, when used as a polymer dispersion, can enable glass cloths and other substrates to be impregnated more uniformly than the conventional polymer dispersions and therefore can favorably increase the coating weight of the polymer per step. When the aqueous dispersion obtained by the above-mentioned polymerization is used in the form of a powder after post-treatment, the sintering time in the molding process can advantageously be curtailed.

In the following, the present invention is further described citing some examples, which are, however, by no means limitative of the scope of the invention.

### EXAMPLES

### Example 1

### Preparation of PTFE Latex

A 3-liter stainless steel autoclave equipped with a stirring impeller was charged with 1.5 liters of deionized water, 60 g of paraffin wax (melting point: 60° C.) and 390 mg of the surfactant 1, and the system atmosphere was substituted with TFE. The inside temperature was raised to 70° C., TFE was fed to the autoclave under pressure until arrival of the inside pressure at 0.78 MPaG and, then, 5 g of a 0.6% (by mass) aqueous solution of ammonium persulfate [APS] was added to initiate the reaction. Since otherwise the pressure in the polymerization system dropped with the advance of the polymerization, TFE was continuously fed to maintain the inside pressure at 0.78 MPaG. The reaction was continued in this manner and, at 4 hours after the initiation of the polymerization, the residual TFE was purged off and the polymerization was thus terminated. The resulting aqueous dispersion was subjected to physical property measurements using the methods described below. The results are shown in Table 1.

Solid matter concentration: The aqueous dispersion obtained was dried at 150° C. for 1 hour, and the concentration was calculated based on the loss in mass. Standard specific gravity (SSG): The measurement was made according to ASTM D 1457-69.

Average primary particle diameter: After dilution to a solid matter concentration of about 0.02% by mass, the diameter in question was indirectly determined based on the transmittance at 550 nm using a working curve showing the relation between the transmittance, per unit length, of incident light at 550 nm and the average particle diameter determined by electron photomicrography.

### Examples 2 and 3

Polymers were produced in the same manner as in Example 1 except for the changes in surfactant species and content as shown in Table 1. They were subjected to the same physical property measurements. The results are shown in Table 1.

### Comparative Example 1

A polymer was produced in the same manner as in Example 1 except for the use of the surfactant 4 (F(CF₂CF₂)₃CF₂COONH₄). It was subjected to the same physical property measurements. The results are shown in Table 1.

TABLE 1

| | | Surfactant | | | |
|---|---|---|---|---|---|
| | | Example | Example | Example | Comparative |
| | | 1 | 2 | 3 | Example 1 |
| | | Species | | | |
| | | Surfactant | Surfactant | Surfactant | Surfactant |
| | | 1 | 2 | 3 | 4 |
| | Amount | 390 | 474 | 400 | 240 |
| | (mass) | | | | |
| Polymeriza- | Hours | 6.6 | 4.7 | 6.7 | 3.4 |
| tion time | | | | | |
| Solid | % by | 17.2 | 13.2 | 15.5 | 16.8 |
| matter | mass | | | | |
| concen- | | | | | |
| tration | | | | | |
| SSG | | 2.227 | 2.215 | 2.221 | 2.205 |
| Average | nm | 174 | 173 | 185 | 256 |
| primary | | | | | |
| particle | | | | | |
| diameter | | | | | |

Surfactant 1: H(CF₂CF₂)ₐCH₂OCOCH(SO₃Na)CH₂COOCH₂(CF₂CF₂)_{b}H (the average of a and the average of b each being 2.25)
Surfactant 2: H(CF₂CF₂)₃CH₂OCOCH(SO₃Na)CH₂COOCH₂(CF₂CF₂)₃H
Surfactant 3: F(CF₂CF₂)₂CH₂CH₂OCOCH(SO₃Na)CH₂COOCH₂CH₂(CF₂CF₂)₂F
Surfactant 4: F(CF₂CF₂)₃CF₂COONH₄

As shown in Table 1, it was found that each of the polymers of Examples 1 to 3 as obtained by using the surfactant of the invention had an average primary particle diameter smaller than 200 nm, whereas the polymer of Comparative Example 1 as obtained using a conventional surfactant, namely the surfactant 4, had an average primary particle diameter exceeding 250 nm.

1. A surfactant comprising a fluorine-containing-sulfobutanedioic-acid-ester derivative represented by the general formula (i):
Y—Rf¹—(CH₂)ₘ—OCOCH(SO₃M)-CH₂COO—(CH₂)ₙ—Rf²—Y (i)
wherein Y represents hydrogen atom or fluorine atom; when Y is hydrogen atom, one of Rf¹ and Rf² is —(CF₂CF₂)₃— and the other is —(CF₂CF₂)₂— or —(CF₂CF₂)₃— and, when Y is fluorine atom, Rf¹ and Rf² are the same or different and each is a divalent hydrocarbon group containing 1 to 4 carbon atoms and containing at least one fluorine atom; m and n are the same or different and each represents an integer of 1 to 3; and M represents NH₄, Li, Na, K or H.

2. The surfactant according to claim 1, wherein Y is hydrogen atom and m and n each is 1.

3. The surfactant according to claim 1, wherein Y is fluorine atom, Rf¹ and Rf² are the same or different and each is a divalent perfluorocarbon group containing 1 to 4 carbon atoms and m and n each is 2.

4. The surfactant according to claim 1, wherein the fluorine-containing-sulfobutanedioic-acid-ester derivative comprises:
H(CF₂CF₂)₃CH₂OCOCH(SO₃Na)CH₂COOCH₂(CF₂CF₂)₂H,
H(CF₂CF₂)₃CH₂OCOCH(SO₃Na)CH₂COOCH₂(CF₂CF₂)₃H and/or
F(CF₂CF₂)₂CH₂CH₂OCOCH(SO₃Na)CH₂COOCH₂CH₂(CF₂CF₂)₂F.

5. The surfactant according to claim 1, which comprises a molecular assembly represented by the general formula (ii):
H(CF₂CF₂)ₐCH₂OCOCH(SO₃Na)CH₂COOCH₂(CF₂CF₂)_{b}H (ii)
wherein the average of a and the average of b are 2.05 to 2.95.

6. A method of producing a fluoropolymer, which comprises producing the fluoropolymer by carrying out a polymerization in an aqueous medium in the presence of the surfactant according to claim 1.

7. The method of producing a fluoropolymer according to claim 6, wherein the surfactant is added in an amount of 0.0001 to 15% by mass relative to the aqueous medium at the time of initiation of the polymerization.

8. A fluoropolymer aqueous dispersion, wherein a particle comprising a fluoropolymer is dispersed in an aqueous medium in the presence of the surfactant according to claim 1.
